(19) United States
(12) Patent Application Publication
(10) Pub. No.: US 2003/0030782 A1
(43) Pub. Date: Feb. 13, 2003

(54) Six degree of freedom wafer fine stage

(76) Inventors: Douglas C. Watson, Campbell, CA (US); Michael Binnard, Belmont, CA (US)

Correspondence Address: Pennie & Edmonds, LLP, 3300 Hillview Avenue, Palo Alto, CA, 94304, US

(21) Appl. No.: 09/929,739

(22) Filed: Aug. 13, 2001

(51) Int. Cl. G03B 27/58

(52) U.S. Cl. 355/72; 310/10; 310/12; 355/53; 355/76; 378/34

(57) ABSTRACT

An apparatus and method precisely position a table or stage with respect to a frame in six degrees of freedom. The system includes a plurality of actuators between the stage and the frame which adjust the position of the frame in three degrees of freedom. The stage is also attached to at least one block assembly. Adjustment of the block assemblies adjusts the position of the stage with respect to the frame in an additional three degrees of freedom. In the context of photolithographic semiconductor processing, a wafer stage can thereby be precisely positioned with respect to a frame or reticle.

### FIELD OF THE INVENTION

The present invention is directed to a device and method for precisely positioning a stage with six degrees of freedom, and specifically for finely positioning a stage in six degrees of motion for photolithographic semiconductor processing.

### BACKGROUND OF THE INVENTION

A number of fields of science and manufacturing require precise positioning of a stage with respect to another stage, a frame, or other frame of reference. One such field is photolithography, in particular, as applied to semiconductor wafer fabrication.

In these photolithographic systems, a wafer is positioned on a surface, sometimes called a wafer table, which is in turn movable with respect to another surface or frame, sometimes called the wafer stage. The wafer stage may itself be movable. Typically, light passes through a mask mounted on a reticle, through a projection lens, and onto the wafer. The light thereby exposes a pattern on the wafer, as dictated by the mask. Both the reticle and the wafer may be movable, so as to repetitively expose the mask pattern on different portions of the wafer.

An example of such a system is provided in FIG. 1. As shown in that figure, photolithographic processing is performed by an exposure apparatus 10. Generally, a pattern of an integrated circuit is transferred from a reticle 32 onto a semiconductor wafer 62. The exposure apparatus 10 is mounted on a base 99, i.e., a floor, base, or some other supporting structure.

At least some of the components of the exposure apparatus 10 are mounted on a frame 12. In some examples, the frame 12 is rigid. The design of the frame 12 can be varied according to the design requirements of the rest of the exposure apparatus 10. Alternatively, a number of different frames or support structures may be employed to suitably position the various components of the exposure apparatus 10. In the example shown in FIG. 1, the reticle assembly 30 holds and positions the reticle 32, which may be positioned on a reticle stage 34, relative to the lens assembly 50 and the wafer assembly 60. Similarly, the wafer stage 64 holds and positions the wafer 62 with respect to the projected image of the reticle 32. In the prior art, various devices 14 may be employed to achieve such positioning, including linear and planar motors. The requirements for this positioning may vary with the design requirements of the system.

Each of the components of such a system may require precise positioning. In particular, the mask and/or the wafer must be precisely positioned relative to each other and relative to the lens, so that the mask pattern is exposed on the appropriate portion of the wafer. To achieve such positioning, various components of the system may be adjustable. In particular, the reticle and/or the lens may be adjustable. Further, the wafer table and/or the wafer stage may be adjustable. A method of extremely fine adjustment is needed to precisely position the components with respect to each other.

Various designs have been proposed to provide such precise positioning. For instance, U.S. Pat. No. 4,506,204 discloses apparatus for electromagnetic alignment using at least three magnet assemblies in spaced relationship, with coil assemblies positioned in the high-flux region of the magnets. By controlling the current flowing through the coils, force can be applied to adjust the position of the apparatus. Various other devices employ similar magnetic force actuators.

Similarly, U.S. Pat. No. 4,952,858 discloses a system for positioning a stage in a photolithographic system using at least three magnetic coil actuators as well as at least three voice coil actuators. These actuators are mounted between the stage and a sub-stage, and together control the position of the stage in six degrees of freedom. Various other devices employ actuators between the stage and sub-stage, generally employing at least one actuator for each degree of freedom desired.

The disadvantages of these and other prior art systems include the difficulty in their assembly and operation, and the related possibility of errors during operation. These difficulties arise from, among other things, the various complexities associated with positioning and operating six or more force actuators between the stage and the sub-stage.

### SUMMARY OF THE INVENTION

The present invention is directed to a method and apparatus for precisely aligning or positioning a stage in six degrees of freedom. The stage is connected to the frame using at least three actuators, which adjust the stage position in three degrees of freedom. The stage is further connected to at least three block assemblies. Each of these block assemblies is movable with respect to the frame, and thereby provide adjustment of the stage in three additional degrees of freedom.

Preferably, the invention is employed in a system for photolithographic or monolithographic processing, such as the processing relating to the fabrication of semiconductor wafers. A wafer is positioned on some stage, such as a wafer table, which must be positioned precisely to provide proper exposure on the wafer of the mask pattern. The stage may be mounted on and movable with respect to a frame, which may have a fixed position and/or alignment, or may itself be movable for coarse adjustments in position.

As used herein in discussing this embodiment, the x axis and y axis are generally interchangeable and generally form the plane substantially parallel to the surface of the wafer and/or the stage. The z axis is perpendicular to the x-y plane. Rotation about an axis is denoted by the θ symbol; e.g., θₓ refers to rotation about the x axis (or a parallel axis). Obviously, variations of this coordinate system may be employed to describe systems within the scope of the present invention.

At least three actuators are positioned between the stage and the frame. Preferable, magnetic actuators are employed, whereby force is applied by varying the electrical current through a coil positioned in a magnetic field. These actuators allow adjustment of the stage (and wafer) in three degrees of freedom. For instance, these actuators can provide adjustment of the position and/or alignment of the stage in the θₓ, θ_{y}, and z directions if at least three actuators are movable in the z direction and pivotally connected to the stage assembly. Other types of actuators, such as voice coil actuators, may also be used within the scope of the invention.

In addition, the stage is connected to a plurality of blocks or block assemblies. Adjustment of these block assemblies, and/or of the position of the stage relative to the block assemblies, allows adjustment of the stage with respect to an additional three degrees of freedom. For instance, these block assemblies may allow adjustment of the position and/or alignment of the stage in the x, y, and θ_{z} directions.

The block assemblies may be connected by various methods to the stage. For instance, the block assemblies may be connected by flexures, which allow the stage to move relative to a block assembly in at least one degree of freedom. U. S. Pat. No. 5,874,820, which is incorporated herein by reference, discloses such flexures. These flexures are preferably pivotally connected to the stage.

The block assemblies themselves may be movable relative to the frame. For instance, the block assemblies may be positioned on air bearings or balls on a surface which is fixed with respect to the frame. Alternatively, the blocks may be connected by flexures to a surface which is fixed with respect to the frame. Adjustment of the position and/or alignment of the block assemblies may be achieved through well known actuators, such as magnetic actuators or voice coil actuators.

The system of the present invention may be assembled and manufactured by connecting a table to a frame, such that it is movable to the frame in six degrees of freedom. A plurality of table actuators are connected to the table to act on the table and control movement of the table in three degrees of freedom. One or more control members are also connected to the table, and are movable relative to the frame in an additional three degrees of freedom. The control members are connected to one or more control actuators which act directly on the control member to control movement of the control member. The order of these steps is of course exemplary, and may be modified without departing from the present invention.

For a better understanding of these and other aspects of the present invention, reference should be made to the following detailed description taken in conjunction with the accompanying drawings.

### BRIEF DESCRIPTION OF THE DRAWINGS

In the drawings, which are not necessarily to scale:

FIG. 1 is a side schematic view of a prior art photolithographic semiconductor processing system;

FIG. 2 is a side schematic view of a photolithographic semiconductor processing system of the present invention;

FIG. 3 is a side schematic view of a wafer positioning system of one embodiment of the present invention;

FIG. 4a is a top schematic view of a stage connected to three block assemblies of another embodiment of the present invention;

FIG. 4b is a side schematic view of the stage and block assemblies of the embodiment of the present invention shown in FIG. 4a;

FIG. 5 is a partial side schematic view of a block assembly of one embodiment of the present invention, positioned on air bearings;

FIG. 6 is a partial side schematic view of a block assembly of one embodiment of the present invention, positioned on flexures;

FIG. 7 is a schematic flow chart of a process for fabricating a positioning system in accordance with one embodiment of the present invention; and

FIG. 8 is a more detailed schematic flow chart of a portion of the process of FIG. 7 in accordance with one embodiment of the present invention.

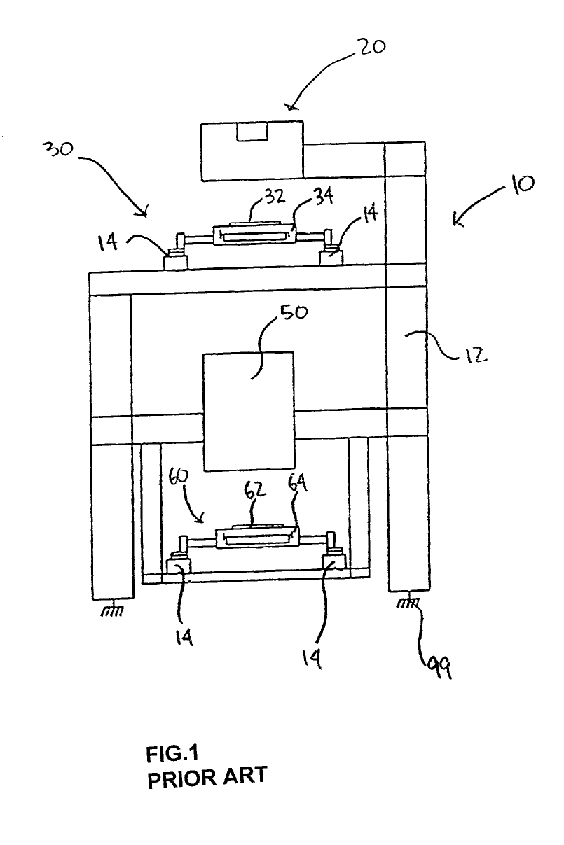

### DETAILED DESCRIPTION OF THE INVENTION

The present invention is directed to a device and method for precisely positioning a stage with respect to a frame in six degrees of freedom. Although the present invention may be used in any application requiring precise positioning of a stage or platform with respect to a frame, the present invention has particular application in a system for photolithographic semiconductor processing.

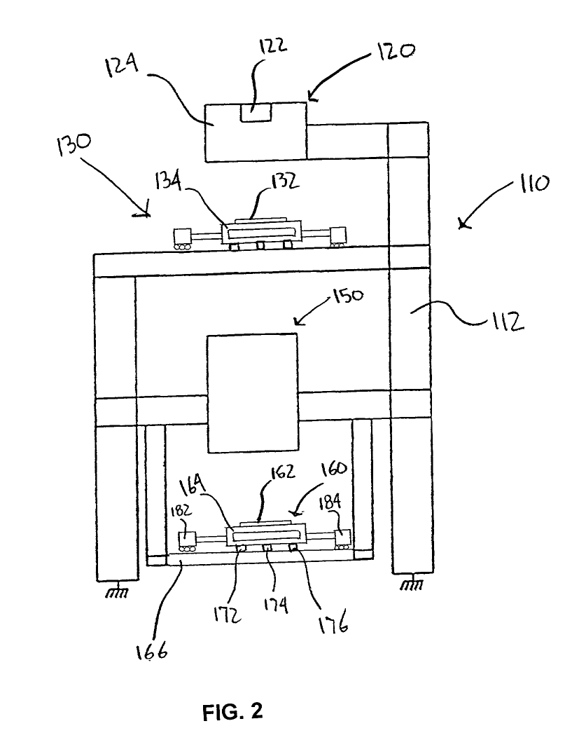

Preferably, the positioning system of the present invention may be employed in a photolithographic semiconductor processing system as shown schematically in FIG. 2. Photolithographic processing is performed by an exposure apparatus 110. The components are mounted on a frame 112. These components include an illumination system 120, a reticle stage 130, a lens assembly 150, and a wafer stage 160. Any well-known variations of these systems, such as those described elsewhere in this patent specification, may be employed within the scope of the present invention.

The illumination system 120 provides a light source for exposure of the wafer. In some examples, the illumination system 120 includes an illumination source 122 and an illumination optical assembly 124. The illumination source 122 emits a beam of light energy. The illumination optical assembly 124 guides the beam of light energy from the illumination source 122 to the lens assembly 150. The beam illuminates selectively different portions of the reticle 132 and exposes the wafer 162. In FIG. 2, the illumination source 122 is supported above the reticle 132. Alternatively, the illumination source is positioned to one side of the of the frame 112, and the optical assembly 124 directs the light energy to the reticle 132.

The illumination source 122 may be any radiant energy source well-known in the art and suitable for the application of the positioning system. For instance, the illumination source 122 may be a g-line (436 nm), i-line (365 nm), KrF excimer laser (248 nm), ArF excimer laser (193 nm) or F₂ laser (157 nm). Alternatively, the illumination source 122 can also use charged particle beams such as x-ray or electron beam. For instance, in the case where an electron beam is used, therionic emission type lanthanum hexaboride (LaB₆) or tantalum (Ta) can be used as an electron gun. Furthermore, in the case where an electron beam is used, the structure may be such that either a mask is used or a pattern can be directly formed on a substrate without the use of a mask.

The lens assembly 150 projects and/or focuses the light passing through the reticle 132 onto the wafer 162. Depending on the design of the exposure apparatus 110, the lens assembly can magnify or reduce the image illuminated on the wafer 62. Various lens assembly designs are well known. For instance, when far ultra-violet rays such as the excimer laser is used, glass materials such as quartz and fluorite that transmit far ultra-violet rays are preferable. When the F₂ type laser or x-ray is used, lens assembly 150 should preferably be either catadioptric or refractive (the reticle should also preferably be a reflective type), and when an electron beam is used, electron optics should preferably comprise electron lenses and deflectors. Such electron lenses, generally, include an assembly of magnetic coils. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 and its counterpart U.S. patent application Ser. No. 873,606 (Application Date: Jun. 12, 1997) also use a reflecting-refracting type of optical system incorporation a concave mirror, etc., but without a beam splitter, and can also be employed. The disclosures in the abovementioned U.S. patents, as well as the Japan Patent applications published in the Official Gazette for Laid-Open Patent Applications are incorporated herein by reference.

In one embodiment, the exposure apparatus 110 can be used as a scanning type photolithography system which exposes the pattern from the reticle 132 onto the wafer 162 with the reticle 132 and the wafer 162 moving synchronously. In a scanning type lithographic device, reticle 132 is moved perpendicular to an optical axis of lens assembly 78 by reticle stage 134 and wafer 162 is moved perpendicular to an optical axis of lens assembly 150 by wafer stage 160. Scanning of reticle 132 and wafer 162 occurs while reticle 132 and wafer 162 are moving synchronously.

Alternatively, the exposure apparatus 110 may be a step-and-repeat type photolithography system in which the reticle 132 and wafer 162 are stationary, at least with respect to each other, during exposure, and the images on the reticle 132 are sequentially exposed onto fields of the wafer 162. In this type of process, the position of the wafer 162 is constant with respect to the reticle 132 during exposure of an individual field. Subsequently, between consecutive exposure steps, the wafer 162 is consecutively moved by the wafer stage 160 so that the next field of the wafer 162 is brought into the proper position relative to the lens assembly 150 and reticle 132 for exposure. In some examples, the movement of the wafer is substantially in a plane perpendicular to the optical axis of the lens assembly 150. In this way, the pattern of the reticle 132 is repeatedly exposed onto sequential fields of the wafer 162.

The positioning system of the present invention is not limited to a photolithography system for semiconductor manufacturing. Rather, the system of the present invention may be employed in any application where a stage must be precisely positioned with respect to a frame. For instance, the positioning system may be employed as an LCD photolithography system that exposes a liquid crystal display device pattern onto a rectangular glass plate or a photolithography system for manufacturing a thin film magnetic head. Further, the present invention may be applied to a proximity photolithography system that exposes a mask pattern by closely locating a mask and substrate without the use of a lens assembly. Additionally, the present invention may be used in other devices, including other semiconductor processing equipment, machine tools, metal cutting machines, and inspection machines.

In the context of a photolithography system for semiconductor processing, the positioning system of the present invention may have various applications. Referring again to FIG. 2, the positioning system may be employed to position the illumination assembly 120, the reticle stage 130, the lens assembly 150, the wafer stage 160, specific components of any of those assemblies or of other components of the exposure apparatus 110, and/or some combination of any of those assemblies or components. Similarly, the positioning system may be employed to position various components of any system where precise positioning of one component with respect to another is needed. As discussed in more detail below, the positioning system generally includes a plurality of specifically arranged actuators 172, 174, 176 between a supporting component 164 (for example a wafer or reticle table) and a frame 166. Those actuators position the component 164 in three degrees of freedom. The system also includes a plurality of block members 182, 184 which position the component 164 in an additional three degrees of freedom.

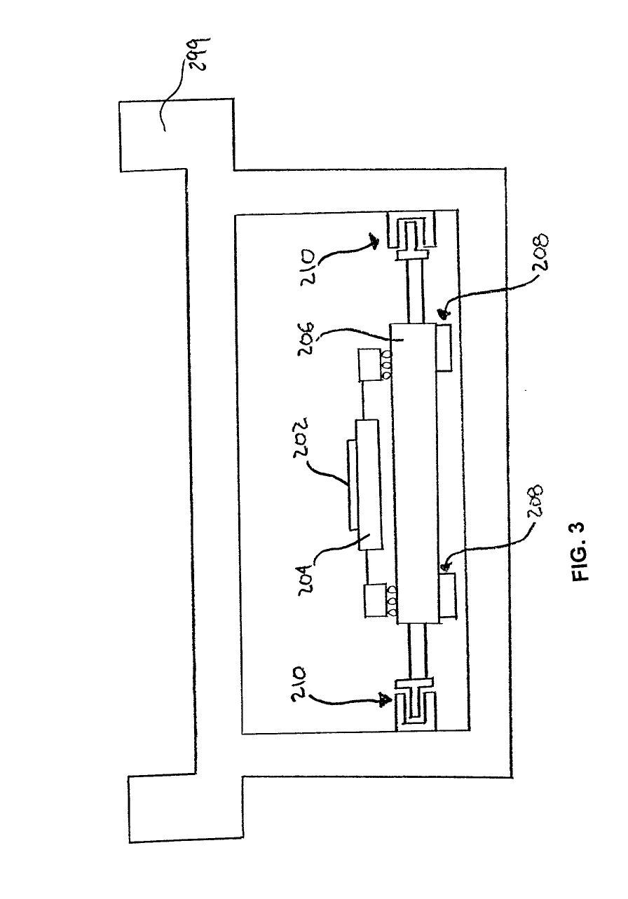

FIG. 3 illustrates in more detail an embodiment of the present invention in the context of wafer processing. As shown in FIG. 3, a wafer 202 is positioned on a wafer table 204. The wafer table 204 itself is positioned on, or movable with respect to, a wafer stage 206. The wafer stage 206 is also movable with respect to a frame 299. The terms wafer stage and wafer table are merely exemplary, and those of skill in the art will recognize that the terms may be interchanged, and that other terms may be used to refer to the two movable frames 204 and 206.

In the embodiment shown in FIG. 3, the wafer table 204 is movable with respect to the wafer stage 206, and the wafer stage is movable with respect to the frame 299. Preferably, the position of the wafer stage 206 can be adjusted for coarse positioning of the wafer 202, while the positioning of the wafer table 204 with respect to the wager stage 206 can be adjusted for finer positioning of the wafer 202. This type of nested positionability is a preferred design choice, but is not required to practice the invention.

In FIG. 3, the wafer stage is schematically shown connected to the frame 299 through a number of mechanisms, including a bearing 208 and/or a magnetic actuator 210. The mechanisms shown in FIG. 3 are figuratively shown and, moreover, merely exemplary. Coarse positioning of the wafer stage may be achieved through various mechanisms well known in the art. Examples of such mechanisms include linear motors of the air levitation type employing air bearings or a magnetic actuator (sometimes referred to as a magnetic levitation type actuator or an E-I core) using Lorentz force or reactance force (see U.S. Pat. Nos. 5,623,853 or 5,528,118, both of which are incorporated herein by reference). Other examples include a planar motor, another type of magnetic actuator which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the frame. Additionally, the wafer stage 206 could move along a guide.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As discussed above, the present invention is directed to fine positioning of a platform or stage with respect to a frame. In the example shown in FIG. 3, the wafer table 204 is finely or precisely positioned with respect to the wafer stage 206. Alternatively, the wafer stage 206 might be finely positioned with respect to the frame 299. Other components of that example could also be finely positioned in accordance with the present invention.

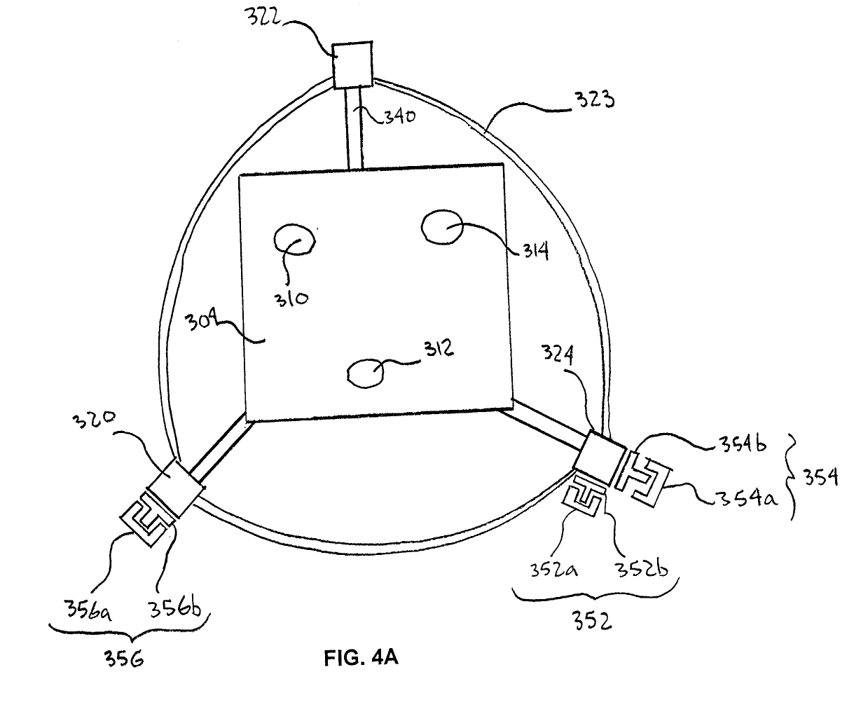

FIGS. 4a and 4b show a system for finely positioning a stage in accordance with the present invention. In the context of a wafer processing system, a wafer table 304 is finely positioned with respect to a wafer stage 306. The wafer table 304 is connected to the wafer stage 306 using a plurality of actuators 310, 312, and 314. These actuators adjust the wafer table 304 in at least three degrees of freedom with respect to the wafer stage 306. For instance, the actuators may include three actuators each of which is movable in the z direction. Those three actuators could then adjust the wafer table 304 in the z direction by moving in unison. Alternatively, adjustment of the actuators, other than in unison, may adjust the wafer table 304 in the θₓ and/or the θ_{y} direction.

In addition, the gravitational weight of the wafer table 304 may be offset by springs 315, 317, bellows (not shown) or other devices well known in the art for supporting weight. The use of such devices reduce the amount of force required by the actuators 310, 312, and 314.

As shown in FIG. 4b, the actuators 310, 312, and 314 are preferably magnetic actuators. These magnetic actuators may include a combination of at least one electromagnet and target. In this embodiment, the electromagnet 352a, 354a, and 356a of each magnetic actuator is attached to the wafer stage 306, and the target 352b, 354b, and 356b of each magnetic actuator is attached to the bottom of the wafer table 304. Alternatively, other types of actuators, such as voice coil actuators utilizing a Lorentz Force, may be employed within the scope of the present invention. Additionally, the number, positioning, and alignment of the actuators may be adjusted as desired.

In addition to the actuators 310, 312, and 314, the wafer table 304 is also connected to a plurality of block assemblies 320, 322, and 324. These block assemblies may adjust the position of the wafer table 304 in an additional three degrees of freedom. For instance, the block assemblies may be movable in the x-y plane. Adjustment of the block assemblies in the x and y directions, therefore, allows adjustment of the wafer table 304 in those directions. Similarly, rotation of the block assemblies about the z axis allows adjustment of the wafer table 304 in the θ_{z} direction. Movement of the block assemblies themselves may be accomplished through various mechanisms well known in the art. For instance, as shown in FIG. 4a, magnetic actuators 352, 354, 356 may be employed. The magnetic actuator 352, 354, and 356 may be comprised of at least one electromagnet and target. In this embodiment, the electromagnet of each magnetic actuator is attached to the wafer stage 306, and the target of each magnetic actuator is attached to the block assemblies 320, 322, and 324. Other types of actuators such as voice coil motors utilizing a Lorentz Force, linear motors, planar motors, and/or some combination thereof may also be employed.

Preferably, one or more of the block assemblies are connected together. For instance, the block assemblies 320, 322, and 324, may be connected by a connecting frame 323. Accordingly, the actuators 352, 354, and 356, may be positioned on one or more of the block assemblies to provide position adjustment of one or more of the block assemblies. Alternatively, one or more of the actuators may be positioned on the connecting frame (not shown).

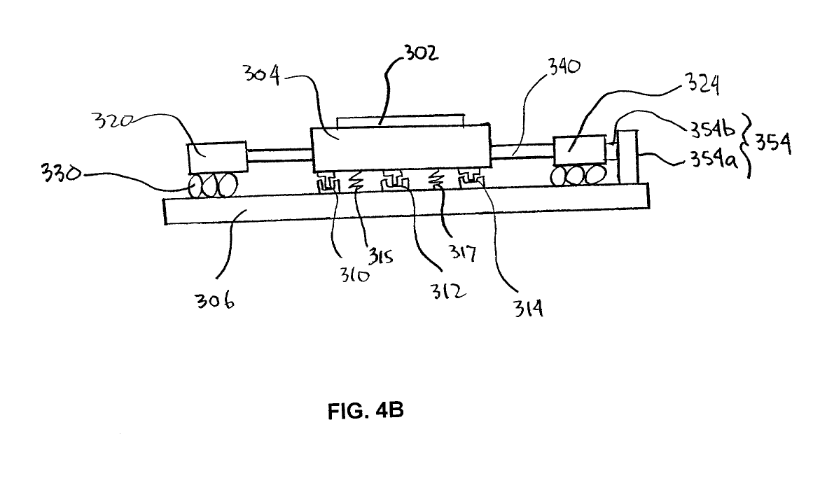

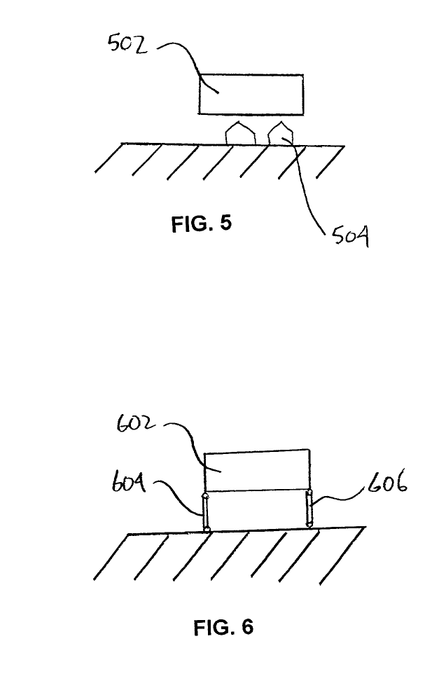

In the embodiment shown in FIG. 4b, the block assemblies 320, 322, and 324 are mounted on ball-type bearings 330 on the wafer stage 306. Other well-known mechanisms may also be employed, so long as the block assembly is suitably movable with respect to the wafer stage 306. For instance, as shown schematically in FIG. 5, a block assembly 502 may be mounted on air bearings 504. In another embodiment of the invention, as shown schematically in FIG. 6, a block assembly 602 may be mounted on flexures 604, 606.

Further, the block assemblies 320, 322, and 324 may be connected to the wafer table 304 by various mechanisms. For instance, the block assemblies may be connected to the wafer table by flexures 340, such as are disclosed in U. S. Pat. No. 5,874,820, which is incorporated herein by reference. Such flexures 340 may permit the wafer table to move relative to each block assembly in one or more degrees of freedom. For instance, the flexures 340 may be composed of flat members that are very flexible in only one direction (in this case, the z direction). The flexures 340 therefore constrain movement in other directions. In this embodiment, three flexures extend radially from the wafer table with the same angle between each as shown in FIG. 4a. Each flexure is connected to the block assemblies 320, 322, and 324 respectively. One magnetic actuator 352 adjusts the position of a first block assembly 324 in a first direction. A second magnetic actuator (not shown) adjusts the position of a second block assembly 322 in a second direction, which differs from the first direction. A third magnetic actuator 356 adjusts the position of a third block assembly 320 in a third direction, which differs from the first and second directions. The position of the wafer table 304 is adjusted by combination of the driving forces generated by the three magnetic actuators 352, 354, and 356.

Preferably, the flexures are pivotally connected to the block assembly and/or the wafer table 304. These pivotal connections may include a hinged connection, allowing rotation about a single axis, or they include a ball and socket type connection, allowing rotation about more than one axis. Such pivotal connections allow fine adjustments of the wafer table 304 in the θₓ, θ_{y} and z directions without requiring similar movement of the block assemblies 320, 322, and 324. Corresponding pivotal connections may be employed between the flexures 340 and the wafer table itself. Similarly, flexures may be employed to position one or more of the block assemblies 320, 322, and 324 on the wafer stage 306.

In operation, the system of the present invention provides precise positioning of the wafer 302. Coarse positioning of the wafer with respect to the frame 299 (and therefore with respect to the reticle, which is not shown in FIGS. 3 and 4) is achieved by adjusting the position of the wafer stage 306. The positioning of the wafer table 304 with respect to the wafer stage 306 is provided in six degrees of freedom. First, the position in three degrees of freedom is achieved using actuators 310, 312, and 314. In the case where magnetic actuators are employed, the position is adjusted using precisely coordinated and calculated variation is the electric current to the actuators. The position in an additional three degrees of freedom then provided by adjusting the position of the block assemblies 320, 322, and 324. Well known methods of measuring the position of the wafer stage, such as interfermometer systems, may be employed as part of this process.

The simplicity of this design in comparison to the prior art provides advantages in assembly and manufacture. Correspondingly, the system is easier to operate and more reliable because of, among other things, the reduced likelihood of errors in assembly and calibration.

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

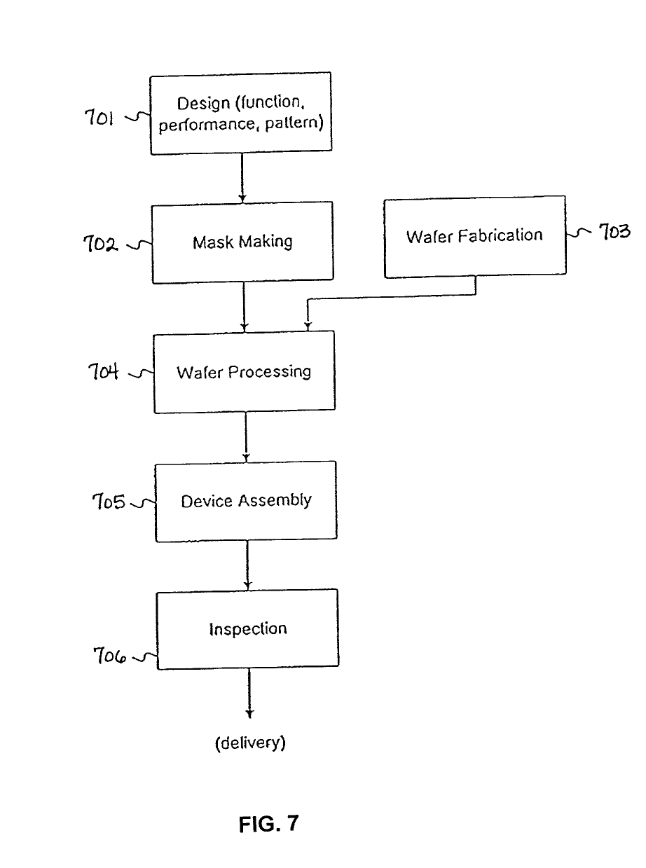

Further, semiconductor devices can be fabricated using the above described systems, by the process shown generally in FIG. 7. In step 701 the device's function and performance characteristics are designed. Next, in step 702, a mask (reticle) having a pattern is designed according to the previous designing step, and in a parallel step 703, a wafer is made from a silicon material. The mask pattern designed in step 702 is exposed onto the wafer from step 703 in step 704 by a photolithography system described hereinabove consistent with the principles of the present invention. In step 705, the semiconductor device is assembled (including the dicing process, bonding process and packaging process), then finally the device is inspected in step 706.

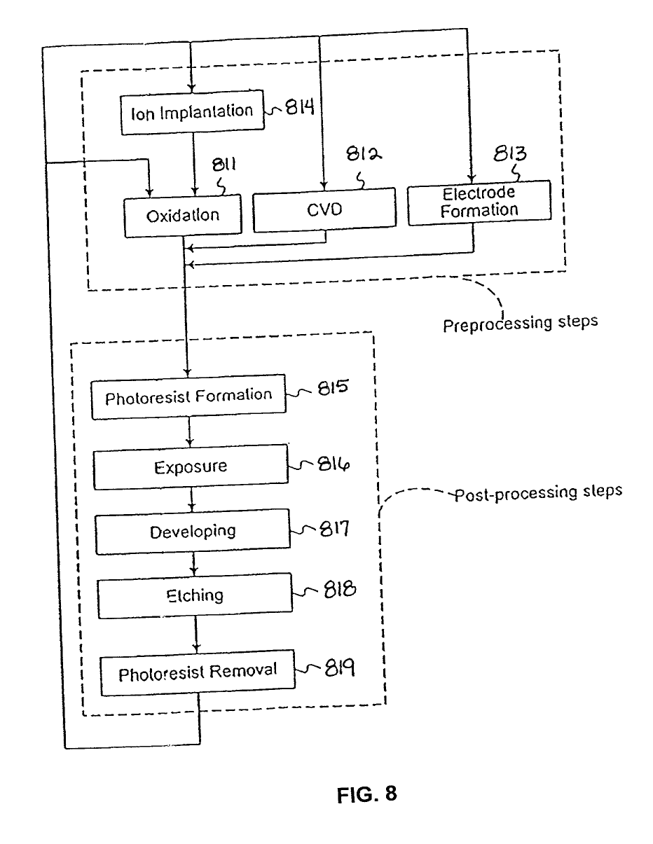

FIG. 8 illustrates a detailed flowchart example of the above-mentioned step 704 in the case of fabricating semiconductor devices. In step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 815 (photoresist formation step), photoresist is applied to a wafer. Next, in step 816 (exposure step), the above-mentioned exposure device is used to transfer the circuit pattern of a mask (reticle) to a wafer. Then, in step 817 (developing step), the exposed wafer is developed, and in step 818 (etching step), parts other than residual photoresist (exposed material surface) are removed by etching. In step 819 (photoresist removal step), unnecessary photoresist remaining after etch is removed.

Multiple circuit patterns are formed by repetition of these preprocessing and post-processing steps.

It will be apparent to those skilled in the art that various modifications and variations can be made in the methods described, in the stage device, the control system, the material chosen for the present invention, and in construction of the photolithography systems as well as other aspects of the invention without departing from the scope or spirit of the invention.

Again, the present invention is not limited to photolithographic semiconductor processing. To the contrary, the present invention may be employed in any application requiring precise positioning of a stage 304 with respect to some frame 306. Those skilled in the art to which the invention pertains may make modifications and other embodiments employing the principles of this invention without departing from its spirit or essential characteristics particularly upon considering the foregoing teachings. The described embodiments are to be considered in all respects only as illustrative and not restrictive and the scope of the invention is, therefore, indicated by the appended claims rather than by the foregoing description Consequently, while the invention has been described with reference to particular embodiments, modifications of structure, sequence, materials and the like would be apparent to those skilled in the art, yet still fall within the scope of the invention.

What is claimed is:

1. A positioning system, comprising:
a frame;
a table mounted on the frame and movable relative to the frame in at least six degrees of freedom;
at least one table actuator acting on the table to control movement of the table in at least one degree of freedom;
at least one control member attached to the table and movable relative to the frame in at least a second degree of freedom.; and
a plurality of control actuators acting directly on a first said control member to control movement of the first said control member.

2. The positioning system of claim 1, said table actuator acting on the table to control movement of the table in at least three degrees of freedom.

3. The positioning system of claim 1, said control member movable relative to the frame in at least three degrees of freedom.

4. The positioning system of claim 1, said table movable relative to said frame in six degrees of freedom.

5. The positioning system of claim 1, wherein at least one said control member is movable relative to the frame in the x, y, and θ_{z} directions; and the table is movable relative to at least one of the control members in the θₓ, θ_{y}, and z directions.

6. The positioning system of claim 1, comprising three said table actuators.

7. The positioning system of claim 1, wherein each said table actuator is adjustable relative to the frame in the z direction.

8. The positioning system of claim 6, wherein a first said table actuator is a magnetic actuator.

9. The positioning system of claim 1, wherein said first control member is adjustable relative to the frame in the x direction and the y direction.

10. The positioning system of claim 1, wherein said first control member is connected to the frame by air bearings.

11. The positioning system of claim 1, wherein said first control member is connected to the frame by ball bearings.

12. The positioning system of claim 1, wherein said first control member is connected to a second said control member.

13. The positioning system of claim 1, wherein said first control member is connected to the frame by one or more flexures.

14. The positioning system of claim 13, wherein at least one of said flexures is pivotally connected to the frame.

15. The positioning system of claim 1, wherein a first said control actuator is a magnetic actuator.

16. The positioning system of claim 1, further comprising a plurality of support members positioned between the table and the frame, which substantially support the gravitational weight of the table.

17. The positioning system of claim 1, further comprising a connecting member that connects the table and at least one said control member, the connecting member being flexible in only one direction.

18. The positioning system of claim 17, wherein said one direction is substantially the same as the direction of the force generated by the table actuator.

19. The positioning system of claim 1, wherein said first control member is movable relative to the frame in three degrees of freedom.

20. A positioning system comprising:
a table mounted on a frame;
actuator means for directly adjusting the position of the table with respect to the frame;
at least one control member connected to the table such that movement of the control members causes movement of the table;
control means for directly adjusting the position of the control members with respect to the frame.

21. A semiconductor processing system, comprising:
a table mounted on a frame;
actuator means for directly adjusting the position of the table with respect to the frame;
at least one control member connected to the table such that movement of the control members causes movement of the table;
control means for directly adjusting the position of the control members with respect to the frame.

22. A semiconductor processing system, comprising:
a source of radiant energy;
a reticle positioned so that the radiant energy is directed onto the reticle;
a wafer positioned on a table so that the radiant energy strikes the wafer after passing through the reticle;
the table mounted on a frame and movable relative to the frame in three degrees of freedom;
a plurality of table actuators positioned between the table and the frame;
at least one block each positioned between the table and the frame and connected to the table such that movement of the blocks controls movement of the table in at least an additional degree of freedom;
at least one block actuator acting on a first said block to control movement of the first block.

23. A device manufactured using the semiconductor processing system of claim 22.

24. A wafer on which an image has been formed by the semiconductor processing system of claim 22.

25. A processing system, comprising:
a workpiece mounted on a platform;
means for directing radiant energy onto the workpiece;
a first means for adjusting the position of the workpiece with respect to the platform in at least one degree of freedom;
a second means for adjusting the position of the workpiece with respect to the platform in an additional degree of freedom.

26. A positioning system, comprising:
a table mounted on a frame;
a table actuator positioned to directly adjust the position of the table with respect to the frame;
at least one control member connected to the table such that movement of the control member causes movement of the table; and
a control actuator positioned to adjust the position of the control members with respect to the frame.

27. The positioning system of claim 26, said table actuator comprising a magnetic actuator.

28. A processing system, comprising:
a workpiece mounted on a platform;
a source of radiant energy positioned to direct radiant energy onto the workpiece;
a first actuator assembly adapted to adjust the position of the workpiece with respect to the platform in at least one degree of freedom;
a second actuator assembly adapted to adjust the position of the workpiece with respect to the platform in an additional degree of freedom.

29. The processing system of claim 28, further comprising a plurality of control members, each said control member pivotally connected to the workpiece; and said second actuator assembly comprising a control actuator positioned to adjust the position of a control member.

30. The processing system of claim 29, a first said control member connected to the workpiece through a flexible member.

31. The processing system of claim 28, wherein said first actuator assembly adjusts the position of the workpiece with respect to the platform in three degrees of freedom; and
said second actuator assembly adjusts the position of the workpiece with respect to the platform in an additional three degrees of freedom.

32. A semiconductor processing system, comprising:
a table mounted on a frame;
a table actuator positioned to directly adjust the position of the table with respect to the frame;
at least one control member connected to the table such that movement of the control member causes movement of the table; and
a control actuator positioned to adjust the position of the control members with respect to the frame.

33. A method of positioning a table relative to a frame, comprising:
adjusting the position of the table relative to the frame in the θₓ, θ_{y}, and z directions using a plurality of support assemblies between the table and the frame, each said support assembly adjustable in the z direction; and
adjusting the position of the table relative to the frame in the x, y, and θ_{z} directions using one or more block assemblies, a first said block assembly adjustable in the x direction, the y direction, and the θ_{z} direction.

34. The method of claim 33, wherein the position of said first block assembly is adjusted using a magnetic actuator.

35. A method for making a positioning system, comprising:
providing a frame;
providing a table mounted on the frame and movable relative to the frame in six degrees of freedom;
connecting a plurality of table actuators to the table that act on the table and control movement of the table in three degrees of freedom;
connecting at least one control member to the table, the control member being movable relative to the frame in an additional three degrees of freedom; and
connecting a plurality of control actuators to a first said control member, wherein each said control actuator acts directly on said first control member to control movement of said first control member.

36. A method for making an exposure apparatus utilizing the method of claim 35.

37. A method of making a device including at least an exposure process, wherein the exposure process utilizes the exposure apparatus made by the method of claim 36.

38. A method for making a wafer utilizing the exposure apparatus made by the method of claim 36.
